(19) United States
(12) Patent Application Publication
(10) Pub. No.: US 2025/0052983 A1
(43) Pub. Date: Feb. 13, 2025

(54) OPTICAL SYSTEM, OPTICAL APPARATUS, AND METHOD FOR MANUFACTURING OPTICAL SYSTEM

(71) Applicant: NIKON CORPORATION, Minato-ku, Tokyo (JP)

(72) Inventors: Kyoya TOKUNAGA, Yokohama-shi (JP); Hiroki HARADA, Zushi-shi (JP); Satoshi YAMAGUCHI, Sagamihara-shi (JP)

(21) Appl. No.: 18/709,495

(22) PCT Filed: Oct. 21, 2022
(86) PCT No.: PCT/JP2022/039293

§ 371 Date: May 11, 2024

(30) Foreign Application Priority Data
Nov. 18, 2021 (JP) 2021-187531

(51) Int. Cl. G02B 15/14; G02B 13/00; G02B 15/20; G02B 27/64

(52) U.S. Cl. CPC G02B 15/145105; G02B 13/0045; G02B 15/1461; G02B 15/20; G02B 27/646

(57) ABSTRACT

An optical system that achieves size reduction in a zoom lens with high magnification and has favorable optical performance, an optical apparatus, and a method for manufacturing the optical system are provided. An optical system OL included in an optical apparatus such as a camera 1 includes, sequentially from an object side, a first lens group G1 having positive refractive power, a second lens group G2 having negative refractive power, a middle group GM constituted by one or two lens groups and having positive refractive power, a focusing group GF that is a lens group having negative refractive power and moves in an optical axis direction at focusing, and a rear group GR constituted by at least one lens group, distance between lens groups adjacent to each other changes at magnification change from a wide-angle end state to a telephoto end state, and the optical system OL satisfies a predetermined condition.

### TECHNICAL FIELD

The present invention relates to an optical system, an optical apparatus, and a method for manufacturing the optical system.

### BACKGROUND ART

Recently, it has been desired for an optical system to ensure sufficient optical performance for a zoom lens with high magnification and achieve size and weight reduction of a lens barrel (refer to Patent Literature 1). However, further improvement of optical performance is required for an optical system disclosed in Patent Literature 1.

### CITATION LIST

### Patent Literature

Patent Literature 1: Japanese Patent Laid-open No. 2017-116645

### SUMMARY OF INVENTION

An optical system according to a first aspect of the present invention includes, sequentially from an object side, a first lens group having positive refractive power, a second lens group having negative refractive power, a middle group constituted by one or two lens groups and having positive refractive power, a focusing group that is a lens group having negative refractive power and moves in an optical axis direction at focusing, and a rear group constituted by at least one lens group, distance between lens groups adjacent to each other changes at magnification change from a wide-angle end state to a telephoto end state, and the optical system satisfies a condition expressed by expressions below,

$$\begin{matrix}1. < f 1 / ( - f 2 ) < 10. \\ 0.01 < Bfaw / fw < 0.55\end{matrix}$$

in the expressions,
f1: focal length of the first lens group,
f2: focal length of the second lens group,
Bfaw: back focus (air-conversion length) of the optical system in the wide-angle end state, and
fw: overall focal length of the optical system in the wide-angle end state.

An optical system according to a second aspect of the present invention includes, sequentially from an object side, a first lens group having positive refractive power, a second lens group having negative refractive power, a middle group constituted by one or two lens groups and having positive refractive power, a focusing group that is a lens group having negative refractive power and moves in an optical axis direction at focusing, and a rear group constituted by at least one lens group, distance between lens groups adjacent to each other changes at magnification change from a wide-angle end state to a telephoto end state, and the optical system satisfies a condition expressed by expressions below,

0.01<|fMRw/fMw|<5.00

0.01<TLt/ft<1.50
in the expressions,
fMRw: combined focal length of a lens group disposed on an image side of the middle group in the wide-angle end state,
fMw: focal length of the middle group in the wide-angle end state,
TLt: total length of the optical system in a telephoto end state, and
ft: overall focal length of the optical system in the telephoto end state.

A method for manufacturing an optical system according to the first aspect of the present invention is a method for manufacturing an optical system including, sequentially from an object side, a first lens group having positive refractive power, a second lens group having negative refractive power, a middle group constituted by one or two lens groups and having positive refractive power, a focusing group that is a lens group having negative refractive power and moves in an optical axis direction at focusing, and a rear group constituted by at least one lens group, and the method includes disposing the lens groups so that distance between lens groups adjacent to each other changes at magnification change from a wide-angle end state to a telephoto end state, and disposing the lens groups so that a condition expressed by expressions below is satisfied,

$$\begin{matrix}1. < f 1 / ( - f 2 ) < 10. \\ 0.01 < Bfaw / fw < 0.55\end{matrix}$$

in the expressions,
f1: focal length of the first lens group,
f2: focal length of the second lens group,
Bfaw: back focus (air-conversion length) of the optical system in the wide-angle end state, and
fw: overall focal length of the optical system in the wide-angle end state.

### BRIEF DESCRIPTION OF DRAWINGS

FIG. 1 is a cross-sectional view showing a lens configuration of an optical system according to a first example at focusing at infinity in a wide-angle end state.

FIG. 2 shows a variety of aberration diagrams of the optical system according to the first example at focusing at infinity: (a) shows the wide-angle end state; and (b) shows a telephoto end state.

FIG. 3 is a cross-sectional view showing a lens configuration of an optical system according to a second example at focusing at infinity in a wide-angle end state.

FIG. 4 shows a variety of aberration diagrams of the optical system according to the second example at focusing at infinity: (a) shows the wide-angle end state; and (b) shows a telephoto end state.

FIG. 5 is a cross-sectional view showing a lens configuration of an optical system according to a third example at focusing at infinity in a wide-angle end state.

FIG. 6 shows a variety of aberration diagrams of the optical system according to the third example at focusing at infinity: (a) shows the wide-angle end state; and (b) shows a telephoto end state.

FIG. 7 is a cross-sectional view of a camera on which an above-described optical system is mounted.

FIG. 8 is a flowchart for description of a method for manufacturing the above-described optical system.

### DESCRIPTION OF EMBODIMENTS

Preferable embodiments will be described below with reference to the accompanying drawings.

### First Embodiment

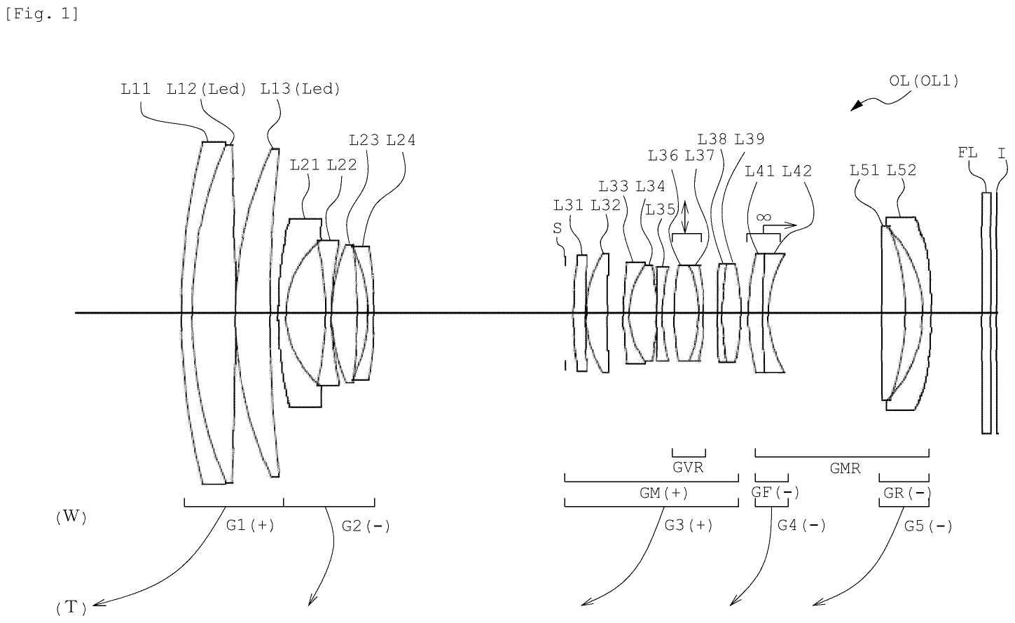

As shown in FIG. 1, an optical system OL according to a first embodiment includes, sequentially from an object side, a first lens group G1 having positive refractive power, a second lens group G2 having negative refractive power, a middle group GM constituted by one or two lens groups and having positive refractive power, a focusing group GF that is a lens group having negative refractive power and moves in an optical axis direction at focusing on from infinity to a close distance object, and a rear group GR constituted by at least one lens group, and the distance between lens groups adjacent to each other changes at magnification change from a wide-angle end state to a telephoto end state. With this configuration, it is possible to achieve size reduction of the optical system OL in a zoom lens with high magnification and obtain favorable optical performance.

Moreover, the optical system OL according to the first embodiment desirably satisfies Conditional Expression (1) shown below.

$$1. < f 1 / ( - f 2 ) < 10. \qquad ( 1 )$$

In the expression,
f1: focal length of the first lens group G1, and
f2: focal length of the second lens group G2.

Conditional Expression (1) defines the ratio of the focal length of the first lens group G1 relative to the focal length of the second lens group G2. When the upper limit value of Conditional Expression (1) is exceeded, the focal length of the second lens group G2 is short and spherical aberration, coma aberration, and curvature of field that occur at the second lens group G2 are large, and accordingly, favorable optical performance is not obtained at magnification change and this is not preferable. Meanwhile, it is possible to secure the advantageous effect of the present embodiment more surely by setting the upper limit value of Conditional Expression (1) to 9.00. Further, in order to secure the advantageous effect of the present embodiment further more surely, it is preferable to set the upper limit value of Conditional Expression (1) to 8.20, and more preferable to 7.50. When the lower limit value of Conditional Expression (1) is exceeded, the focal length of the first lens group G1 is short and spherical aberration, coma aberration, curvature of field that occur at the first lens group G1 are large, and accordingly, favorable optical performance is not obtained at magnification change and this is not preferable. Meanwhile, it is possible to secure the advantageous effect of the present embodiment more surely by setting the lower limit value of Conditional Expression (1) to 2.50. Further, in order to secure the advantageous effect of the present embodiment further more surely, it is preferable to set the lower limit value of Conditional Expression (1) to 4.00, 5.00, and more preferable to 6.00.

Moreover, the optical system OL according to the first embodiment desirably satisfies Conditional Expression (2) shown below.

$$0.01 < Bfaw / fw < 0.55 \qquad ( 2 )$$

In the expression,
Bfaw: back focus (air-conversion length) of the optical system OL at focusing at infinity in the wide-angle end state, and
fw: overall focal length of the optical system OL at focusing at infinity in the wide-angle end state.

Conditional Expression (2) defines the ratio of the back focus (air-conversion length) of the optical system OL relative to the overall focal length in the wide-angle end state. When Conditional Expression (2) is satisfied, it is possible to achieve size reduction of the optical system OL and obtain favorable optical performance. Meanwhile, it is possible to secure the advantageous effect of the present embodiment more surely by setting the upper limit value of Conditional Expression (2) to 0.50. Further, in order to secure the advantageous effect of the present embodiment further more surely, it is preferable to set the upper limit value of Conditional Expression (2) more preferable to 0.45. Moreover, it is possible to secure the advantageous effect of the present embodiment more surely by setting the lower limit value of Conditional Expression (2) to 0.10. Further, in order to secure the advantageous effect of the present embodiment further more surely, it is preferable to set the lower limit value of Conditional Expression (2) to 0.15, 0.20, 0.25, and more preferable to 0.30.

### Second Embodiment

As shown in FIG. 1, an optical system OL according to a second embodiment includes, sequentially from an object side, a first lens group G1 having positive refractive power, a second lens group G2 having negative refractive power, a middle group GM constituted by one or two lens groups and having positive refractive power, a focusing group GF that is a lens group having negative refractive power and moves in an optical axis direction at focusing on from infinity to a close distance object, and a rear group GR constituted by at least one lens group, and the distance between lens groups adjacent to each other changes at magnification change from a wide-angle end state to a telephoto end state. With this configuration, it is possible to achieve size reduction of the optical system OL in a zoom lens with high magnification and obtain favorable optical performance.

Moreover, the optical system OL according to the second embodiment desirably satisfies Conditional Expression (3) shown below.

$$0.01 < \vert fMRw / fMw \vert < 5. \qquad ( 3 )$$

In the expression,
fMRw: combined focal length of a lens group GMR disposed on an image side of the middle group GM at focusing at infinity in the wide-angle end state, and
fMw: focal length of the middle group GM in the wide-angle end state.

Conditional Expression (3) defines the ratio of the combined focal length of the lens group GMR disposed on the image side of the middle group GM relative to the focal length of the middle group GM in the wide-angle end state. When the upper limit value of Conditional Expression (3) is exceeded, the focal length of the middle group GM is short and spherical aberration and coma aberration that occur at the middle group GM are large, and accordingly, favorable optical performance is not obtained at magnification change and this is not preferable. Meanwhile, it is possible to secure the advantageous effect of the present embodiment more surely by setting the upper limit value of Conditional Expression (3) to 4.00. Further, in order to secure the advantageous effect of the present embodiment further more surely, it is preferable to set the upper limit value of Conditional Expression (3) to 3.00, 2.50, and more preferable to 1.30. When the lower limit value of Conditional Expression (3) is exceeded, the combined focal length of the lens group GMR disposed on the image side of the middle group GM is short and spherical aberration, coma aberration, and curvature of field that occur at the lens group GMR disposed on the image side of the middle group GM are large, and accordingly, favorable optical performance is not obtained at magnification change and this is not preferable. Meanwhile, it is possible to secure the advantageous effect of the present embodiment more surely by setting the lower limit value of Conditional Expression (3) to 0.10. Further, in order to secure the advantageous effect of the present embodiment further more surely, it is preferable to set the lower limit value of Conditional Expression (3) to 0.30, 0.45, 0.60, and more preferable to 0.65.

Moreover, the optical system OL according to the second embodiment desirably satisfies Conditional Expression (4) shown below.

$$0.01 < TLt / f t < 1.5 \qquad ( 4 )$$

In the expression,
TLt: total length of the optical system OL at focusing at infinity in a telephoto end state, and
ft: overall focal length of the optical system OL at focusing at infinity in the telephoto end state.

Conditional Expression (4) defines the ratio of the total length of the optical system OL relative to the overall focal length in the telephoto end state. When Conditional Expression (4) is satisfied, it is possible to achieve size reduction of the optical system OL and obtain favorable optical performance. Meanwhile, it is possible to secure the advantageous effect of the present embodiment more surely by setting the upper limit value of Conditional Expression (4) to 1.25. Further, in order to secure the advantageous effect of the present embodiment further more surely, it is preferable to set the upper limit value of Conditional Expression (4) to 1.00, and more preferable to 0.80. Moreover, it is possible to secure the advantageous effect of the present embodiment more surely by setting the lower limit value of Conditional Expression (4) to 0.10. Further, in order to secure the advantageous effect of the present embodiment further more surely, it is preferable to set the lower limit value of Conditional Expression (4) to 0.25, 0.40, and more preferable to 0.50.

### First and Second Embodiments

Moreover, the optical system OL according to the first embodiment desirably satisfies Conditional Expression (3) described above. The advantageous effect and the like obtained by satisfying Conditional Expression (3) are as described above.

Moreover, the optical system OL according to the first embodiment desirably satisfies Conditional Expression (4) described above. The advantageous effect and the like obtained by satisfying Conditional Expression (4) are as described above.

Moreover, the optical system OL according to the second embodiment desirably satisfies Conditional Expression (1) described above. The advantageous effect and the like obtained by satisfying Conditional Expression (1) are as described above.

Moreover, the optical system OL according to the second embodiment desirably satisfies Conditional Expression (2) described above. The advantageous effect and the like obtained by satisfying Conditional Expression (2) are as described above.

Moreover, the optical system OL according to the first and second embodiment (hereinafter referred to as “the present embodiment”) desirably satisfies Conditional Expression (5) shown below.

$$0.05 < fMw / ( - f 2 ) < 3. \qquad ( 5 )$$

In the expression,
fMw: focal length of the middle group GM in the wide-angle end state, and
f2: focal length of the second lens group G2.

Conditional Expression (5) defines the ratio of the focal length of the middle group GM relative to the focal length of the second lens group G2 in the wide-angle end state. When the upper limit value of Conditional Expression (5) is exceeded, the focal length of the second lens group G2 is short and spherical aberration, coma aberration, and curvature of field that occur at the second lens group G2 are large, and accordingly, favorable optical performance is not obtained at magnification change and this is not preferable. Meanwhile, it is possible to secure the advantageous effect of the present embodiment more surely by setting the upper limit value of Conditional Expression (5) to 2.50. Further, in order to secure the advantageous effect of the present embodiment further more surely, it is preferable to set the upper limit value of Conditional Expression (5) to 2.00, and more preferable to 1.60. When the lower limit value of Conditional Expression (5) is exceeded, the focal length of the middle group GM is short and spherical aberration and coma aberration that occur at the middle group GM are large, and accordingly, favorable optical performance is not obtained at magnification change and this is not preferable. Meanwhile, it is possible to secure the advantageous effect of the present embodiment more surely by setting the lower limit value of Conditional Expression (5) to 0.80. Further, in order to secure the advantageous effect of the present embodiment further more surely, it is preferable to set the lower limit value of Conditional Expression (5) to 1.00, and more preferable to 1.30.

Moreover, the optical system OL according to the present embodiment desirably satisfies Conditional Expression (6) shown below.

$$0.5 < ( - fF ) / fMw < 4. \qquad ( 6 )$$

In the expression,
fF: focal length of the focusing group GF, and
fMw: focal length of the middle group GM in the wide-angle end state.

Conditional Expression (6) defines the ratio of the focal length of the focusing group GF relative to the focal length of the middle group GM in the wide-angle end state. When the upper limit value of Conditional Expression (6) is exceeded, the focal length of the middle group GM is short and spherical aberration and coma aberration that occur at the middle group GM are large, and accordingly, favorable optical performance is not obtained at magnification change and this is not preferable. Meanwhile, it is possible to secure the advantageous effect of the present embodiment more surely by setting the upper limit value of Conditional Expression (6) to 3.50. Further, in order to secure the advantageous effect of the present embodiment further more surely, it is preferable to set the upper limit value of Conditional Expression (6) to 3.00, 2.50, and more preferable to 2.00. When the lower limit value of Conditional Expression (6) is exceeded, focal length of the focusing group GF is short and spherical aberration, coma aberration, curvature of field that occur at the focusing group GF are large, and accordingly, favorable close-distance performance is not obtained and this is not preferable. Meanwhile, it is possible to secure the advantageous effect of the present embodiment more surely by setting the lower limit value of Conditional Expression (6) to 0.75. Further, in order to secure the advantageous effect of the present embodiment further more surely, it is preferable to set the lower limit value of Conditional Expression (6) to 1.00, and more preferable to 1.30.

Moreover, the optical system OL according to the present embodiment desirably satisfies Conditional Expression (7) shown below.

$$0.01 < \vert fMw / fRw \vert < 1. \qquad ( 7 )$$

In the expression,
fMw: focal length of the middle group GM in the wide-angle end state, and
fRw: focal length of the rear group GR in the wide-angle end state.

Conditional Expression (7) defines the ratio of the focal length of the middle group GM relative to the focal length of the rear group GR in the wide-angle end state. When the upper limit value of Conditional Expression (7) is exceeded, the focal length of the rear group GR is short and curvature of field that occurs at the rear group GR is large, and accordingly, favorable optical performance is not obtained at magnification change and this is not preferable. Meanwhile, it is possible to secure the advantageous effect of the present embodiment more surely by setting the upper limit value of Conditional Expression (7) to 0.85. Further, in order to secure the advantageous effect of the present embodiment further more surely, it is preferable to set the upper limit value of Conditional Expression (7) to 0.70, 0.50, and more preferable to 0.40. When the lower limit value of Conditional Expression (7) is exceeded, the focal length of the middle group GM is short and spherical aberration and coma aberration that occur at the middle group GM are large, and accordingly, favorable optical performance is not obtained at magnification change and this is not preferable. Meanwhile, it is possible to secure the advantageous effect of the present embodiment more surely by setting the lower limit value of Conditional Expression (7) to 0.06. Further, in order to secure the advantageous effect of the present embodiment further more surely, it is preferable to set the lower limit value of Conditional Expression (7) to 0.10, and more preferable to 0.12.

Moreover, the optical system OL according to the present embodiment desirably satisfies Conditional Expression (8) shown below.

$$0.01 < \vert fF / fRw \vert < 1. \qquad ( 8 )$$

In the expression,
fF: focal length of the focusing group GF, and
fRw: focal length of the rear group GR in the wide-angle end state.

Conditional Expression (8) defines the ratio of the focal length of the focusing group GF relative to the focal length of the rear group GR in the wide-angle end state. When the upper limit value of Conditional Expression (8) is exceeded, the focal length of the rear group GR is short and curvature of field that occurs at the rear group GR is large, and accordingly, favorable optical performance is not obtained at magnification change and this is not preferable. Meanwhile, it is possible to secure the advantageous effect of the present embodiment more surely by setting the upper limit value of Conditional Expression (8) to 0.90. Further, in order to secure the advantageous effect of the present embodiment further more surely, it is preferable to set the upper limit value of Conditional Expression (8) to 0.85, 0.80, and more preferable to 0.70. When the lower limit value of Conditional Expression (8) is exceeded, the focal length of the focusing group GF is short and spherical aberration, coma aberration, curvature of field that occur at the focusing group GF are large, and accordingly, favorable close-distance performance is not obtained and this is not preferable. Meanwhile, it is possible to secure the advantageous effect of the present embodiment more surely by setting the lower limit value of Conditional Expression (8) to 0.10. Further, in order to secure the advantageous effect of the present embodiment further more surely, it is preferable to set the lower limit value of Conditional Expression (8) to 0.15, and more preferable to 0.20.

Moreover, the optical system OL according to the present embodiment desirably satisfies Conditional Expression (9) shown below.

$$0.01 < \vert f 2 / fRw \vert < 1. \qquad ( 9 )$$

In the expression,
f2: focal length of the second lens group G2, and
fRw: focal length of the rear group GR in the wide-angle end state.

Conditional Expression (9) defines the ratio of the focal length of the second lens group G2 relative to the focal length of the rear group GR in the wide-angle end state. When the upper limit value of Conditional Expression (9) is exceeded, the focal length of the rear group GR is short and curvature of field that occurs at the rear group GR is large, and accordingly, favorable optical performance is not obtained at magnification change and this is not preferable. Meanwhile, it is possible to secure the advantageous effect of the present embodiment more surely by setting the upper limit value of Conditional Expression (9) to 0.80. Further, in order to secure the advantageous effect of the present embodiment further more surely, it is preferable to set the upper limit value of Conditional Expression (9) to 0.50, and more preferable to 0.30. When the lower limit value of Conditional Expression (9) is exceeded, the focal length of the second lens group G2 is short and spherical aberration, coma aberration, and curvature of field that occur at the second lens group G2 are large, and accordingly, favorable optical performance is not obtained at magnification change and this is not preferable. Meanwhile, it is possible to secure the advantageous effect of the present embodiment more surely by setting the lower limit value of Conditional Expression (9) to 0.04. Further, in order to secure the advantageous effect of the present embodiment further more surely, it is preferable to set the lower limit value of Conditional Expression (9) to 0.08.

Moreover, the optical system OL according to the present embodiment desirably satisfies Conditional Expression (10) shown below.

$$0.01 < β Ft / β Fw < 2. \qquad ( 10 )$$

In the expression,
βFt: lateral magnification of the focusing group GF at focusing at infinity in the telephoto end state, and
βFw: lateral magnification of the focusing group GF at focusing at infinity in the wide-angle end state.

Conditional Expression (10) defines the ratio of the lateral magnification of the focusing group GF in the telephoto end state relative to the lateral magnification thereof in the wide-angle end state. When Conditional Expression (10) is satisfied, it is possible to achieve size reduction of the optical system OL and obtain favorable optical performance. Meanwhile, it is possible to secure the advantageous effect of the present embodiment more surely by setting the upper limit value of Conditional Expression (10) to 1.80. Further, in order to secure the advantageous effect of the present embodiment further more surely, it is preferable to set the upper limit value of Conditional Expression (10) to 1.73, 1.65, and more preferable to 1.58. Moreover, it is possible to secure the advantageous effect of the present embodiment more surely by setting the lower limit value of Conditional Expression (10) to 0.50. Further, in order to secure the advantageous effect of the present embodiment further more surely, it is preferable to set the lower limit value of Conditional Expression (10) to 0.75, 1.00, and more preferable to 1.20.

Moreover, the optical system OL according to the present embodiment desirably satisfies Conditional Expression (11) shown below.

$$0.01 < β Rt / β Rw < 2. \qquad ( 11 )$$

In the expression,
βRt: lateral magnification of the rear group GR at focusing at infinity in the telephoto end state, and
βRw: lateral magnification of the rear group GR at focusing at infinity in the wide-angle end state.

Conditional Expression (11) defines the ratio of the lateral magnification of the rear group GR in the telephoto end state relative to the lateral magnification thereof in the wide-angle end state. When Conditional Expression (11) is satisfied, it is possible to achieve size reduction of the optical system OL and obtain favorable optical performance. Meanwhile, it is possible to secure the advantageous effect of the present embodiment more surely by setting the upper limit value of Conditional Expression (11) to 1.75. Further, in order to secure the advantageous effect of the present embodiment further more surely, it is preferable to set the upper limit value of Conditional Expression (11) to 1.50. Moreover, it is possible to secure the advantageous effect of the present embodiment more surely by setting the lower limit value of Conditional Expression (11) to 0.50. Further, in order to secure the advantageous effect of the present embodiment further more surely, it is preferable to set the lower limit value of Conditional Expression (11) to 0.75, 1.00, and more preferable to 1.10.

Moreover, in the optical system OL according to the present embodiment, at least part of the middle group GM is desirably an antivibration group GVR that moves with a component in a direction perpendicular to the optical axis. With this configuration, favorable antivibration performance can be obtained.

Moreover, the optical system OL according to the present embodiment desirably satisfies Conditional Expression (12) shown below.

$$0.01 < \vert fMw / fVR \vert < 1.5 \qquad ( 12 )$$

In the expression,
fMw: focal length of the middle group GM in the wide-angle end state, and
fVR: focal length of the antivibration group GVR.

Conditional Expression (12) defines the ratio of the focal length of the middle group GM relative to the focal length of the antivibration group GVR in the wide-angle end state. When the upper limit value of Conditional Expression (12) is exceeded, the focal length of the antivibration group GVR is short and eccentric coma aberration and asymmetric image plane distortion that occur at the antivibration group GVR are large, and accordingly, favorable antivibration performance is not obtained and this is not preferable. Meanwhile, it is possible to secure the advantageous effect of the present embodiment more surely by setting the upper limit value of Conditional Expression (12) to 1.25. Further, in order to secure the advantageous effect of the present embodiment further more surely, it is preferable to set the upper limit value of Conditional Expression (12) to 1.00, 0.90, and more preferable to 0.60. When the lower limit value of Conditional Expression (12) is exceeded, the focal length of the antivibration group GVR is long and the moving amount of the antivibration group GVR at antivibration is large, and thus eccentric coma aberration and asymmetric curvature of field occur, and accordingly, favorable antivibration performance is not obtained and this is not preferable. Meanwhile, it is possible to secure the advantageous effect of the present embodiment more surely by setting the lower limit value of Conditional Expression (12) to 0.10. Further, in order to secure the advantageous effect of the present embodiment further more surely, it is preferable to set the lower limit value of Conditional Expression (12) to 0.20, 0.25, 0.35, and more preferable to 0.40.

Moreover, the optical system OL according to the present embodiment desirably satisfies Conditional Expression (13) shown below.

$$0.01 < \vert fVR / fF \vert < 2. \qquad ( 13 )$$

In the expression,
fVR: focal length of the antivibration group GVR, and
fF: focal length of the focusing group GF.

Conditional Expression (13) defines the ratio of the focal length of the antivibration group GVR relative to the focal length of the focusing group GF. When the upper limit value of Conditional Expression (13) is exceeded, the focal length of the antivibration group GVR is short and eccentric coma aberration and asymmetric curvature of field that occur at the antivibration group GVR are large, and accordingly, favorable antivibration performance is not obtained and this is not preferable. Meanwhile, it is possible to secure the advantageous effect of the present embodiment more surely by setting the upper limit value of Conditional Expression (13) to 1.75. Further, in order to secure the advantageous effect of the present embodiment further more surely, it is preferable to set the upper limit value of Conditional Expression (13) to 1.50. When the lower limit value of Conditional Expression (13) is exceeded, the focal length of the focusing group GF is short and spherical aberration, coma aberration, curvature of field that occur at the focusing group GF are large, and accordingly, favorable close-distance performance is not obtained and this is not preferable. Meanwhile, it is possible to secure the advantageous effect of the present embodiment more surely by setting the lower limit value of Conditional Expression (13) to 0.10. Further, in order to secure the advantageous effect of the present embodiment further more surely, it is preferable to set the lower limit value of Conditional Expression (13) to 0.35, 0.50, 0.75, and more preferable to 0.90.

Moreover, in the optical system OL according to the present embodiment, the antivibration group GVR is desirably disposed between a lens component disposed closest to the object side and a lens component disposed closest to an image side in the middle group GM. With this configuration, favorable antivibration performance can be obtained.

Moreover, in the optical system OL according to the present embodiment, the antivibration group GVR is desirably constituted by one cemented lens. With this configuration, favorable antivibration performance can be obtained.

Moreover, in the optical system OL according to the present embodiment, the focusing group GF is desirably constituted by one cemented lens. With this configuration, chromatic aberration at focusing on a close distance object can be excellently corrected.

Moreover, in the optical system OL according to the present embodiment, the rear group GR desirably has negative refractive power. With this configuration, size reduction can be achieved and favorable optical performance can be obtained.

Moreover, in the optical system OL according to the present embodiment, the first lens group G1 desirably includes at least one lens (hereinafter referred to as a “specific lens Led”) that satisfies Conditional Expression (14) shown below.

$$vd 1 > 75. \qquad ( 14 )$$

In the expression,
νd1: Abbe number of the medium of the specific lens Led at a d line

Conditional Expression (14) defines the Abbe number of the medium of the specific lens Led disposed in the first lens group G1 at the d line. With this configuration, chromatic aberration can be excellently corrected. Meanwhile, it is possible to secure the advantageous effect of the present embodiment more surely by setting the lower limit value of Conditional Expression (14) to 78.00. Further, in order to secure the advantageous effect of the present embodiment further more surely, it is preferable to set the lower limit value of Conditional Expression (14) to 80.00, and more preferable to 82.00.

The conditions and configurations described above each provide the effect described above, and all the conditions and configurations are not necessarily satisfied. An optical system that satisfies any of the conditions or configurations or a combination of any of the conditions or configurations can provide the effects described above.

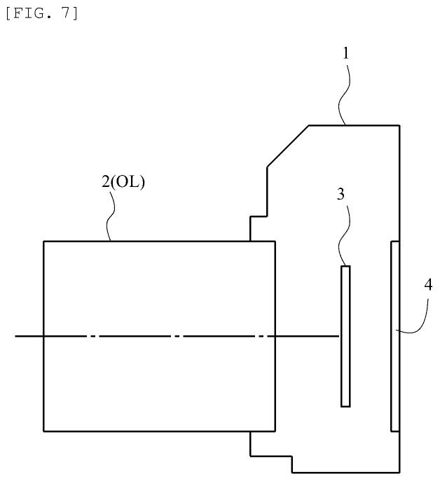

Subsequently, a camera that is an optical apparatus including the optical system OL according to the present embodiment will be described below with respect to FIG. 7. This camera 1 is what is called a lens-interchangeable mirrorless camera including the optical system OL according to the present embodiment as an image pickup lens 2. In the camera 1, light from a non-illustrated object (subject) is condensed through the image pickup lens 2 and forms a subject image on the image surface of an image unit 3 through a non-illustrated optical low pass filter (OLPF). Then, the subject image is photoelectrically converted by a photoelectric conversion element included in the image unit 3 to generate an image of the subject. This image is displayed at an electronic view finder (EVF) 4 provided at the camera 1. Accordingly, a photographer can observe the subject through the EVF 4.

Furthermore, when a non-illustrated release button is pressed by the photographer, the image photoelectrically converted by the image unit 3 is stored in a non-illustrated memory. In this manner, the photographer can capture an image of the subject with the camera 1. Note that although the example of a mirrorless camera is described in the present embodiment, the same effected as those of the above-described the camera 1 can be obtained also when the optical system OL according to the present embodiment is mounted on a single-lens reflex camera that includes a quick-return mirror in a camera body and with which a subject is observed through a finder optical system.

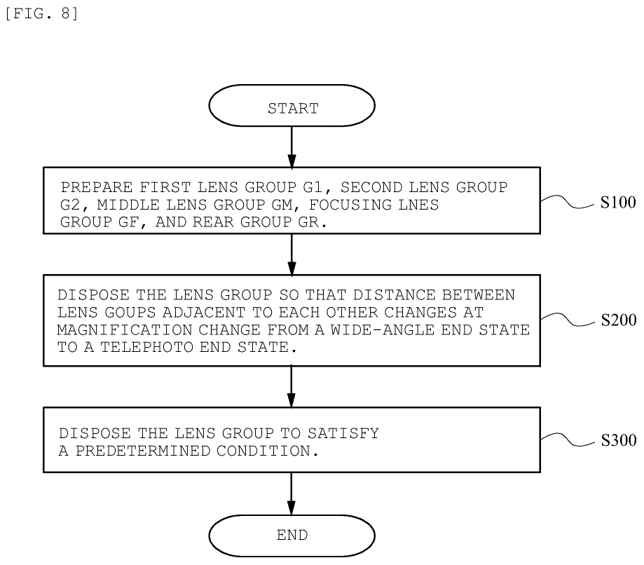

A method for manufacturing the optical system OL according to the present embodiment will be schematically described below with reference to FIG. 8. First, the first lens group G1 having positive refractive power, the second lens group G2 having negative refractive power, the middle group GM constituted by one or two lens groups and having positive refractive power, the focusing group GF that is a lens group having negative refractive power and moves in an optical axis direction at focusing, and the rear group GR constituted by at least one lens group are prepared sequentially from the object side (step S100). Subsequently, the lens groups are disposed so that the distance between lens groups adjacent to each other changes at magnification change from the wide-angle end state to the telephoto end state (step S200). Then, the lens groups are disposed so that a predetermined condition (for example, Conditional Expression (1) described above) is satisfied (step S300).

With the above-described configuration, it is possible to provide an optical system that achieves size reduction in a zoom lens with high magnification and has favorable optical performance, an optical apparatus, and a method for manufacturing the optical system.

### Examples

Examples will be described below with reference to the accompanying drawings. Note that FIGS. 1, 3, and 5 are cross-sectional views showing the configurations and refractive power distribution of optical systems OL (OL1 to OL3) according to the examples. The lower part of each drawing shows the movement locus of each lens group of the corresponding optical system OL from the wide-angle end state (W) to the telephoto end state (T) at magnification change.

In the examples, each aspheric surface is expressed by Expression (a) below, where y represents the height in a direction orthogonal to the optical axis, S (y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E-n” represents “x10⁻ⁿ”.

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} \qquad ( a )$$

Note that, in the examples, the second aspheric surface coefficient A2 is zero.

The examples described below show specific examples of the present application invention, and the present application invention is not limited to the examples.

### First Example

FIG. 1 is a diagram showing the configuration of an optical system OL1 according to a first example. The optical system OL1 includes, sequentially from the object side, a first lens group G1 having positive refractive power, a second lens group G2 having negative refractive power, a middle group GM constituted by a third lens group G3 having positive refractive power, a focusing group GF constituted by a fourth lens group G4 having negative refractive power, and a rear group GR constituted by a fifth lens group G5 having negative refractive power.

The first lens group G1 includes sequentially from the object side, a cemented positive lens formed by cementing a negative meniscus lens L11 having a convex surface facing the object side and a biconvex positive lens L12, and a positive meniscus lens L13 having a convex surface facing the object side. Note that the biconvex positive lens L12 and the positive meniscus lens L13 are the specific lens Led.

The second lens group G2 includes, sequentially from the object side, a negative lens L21 having a negative meniscus shape with a convex surface facing the object side and with an aspheric surface formed on a lens surface on the object side, a biconcave negative lens L22, a biconvex positive lens L23, and a negative meniscus lens L24 having a concave surface facing the object side.

The third lens group G3 includes, sequentially from the object side, a positive meniscus lens L31 having a convex surface facing the object side, a positive lens L32 having a biconcave shape with an aspheric surface formed on a lens surface on the image side, a cemented positive lens formed by cementing a negative meniscus lens L33 having a convex surface facing the object side and a biconvex positive lens L34, a biconcave negative lens L35, a cemented positive lens formed by cementing a biconvex positive lens L36 and a negative meniscus lens L37 having a concave surface facing the object side, and a cemented positive lens formed by cementing a negative meniscus lens L38 having a convex surface facing the object side and a biconvex positive lens L39.

The fourth lens group G4 includes a cemented negative lens formed by cementing a positive meniscus lens L41 having a convex surface facing the object side and a negative meniscus lens L42 having a convex surface facing the object side sequentially from the object side.

The fifth lens group G5 includes, sequentially from the object side, a biconvex positive lens L51 and a negative lens L52 having a negative meniscus shape with a concave surface facing the object side and with an aspheric surface formed on a lens surface on the image side.

An aperture stop S is disposed between the second lens group G2 and the third lens group G3. In addition, a filter group FL is disposed between the fifth lens group G5 and an image plane I.

In the optical system OL1, the first lens group G1, the second lens group G2, the third lens group G3, the fourth lens group G4, and the fifth lens group G5 move on the optical axis so that the distance between lens groups adjacent to each other changes at magnification change from the wide-angle end state to the telephoto end state. Note that the aperture stop S moves together with the third lens group G3.

In the optical system OL1, image position correction (antivibration) when camera shake occurs is performed by moving, as the antivibration group GVR, the cemented positive lens formed by cementing the biconvex positive lens L36 and the negative meniscus lens L37 having a concave surface facing the object side in the third lens group G3, with a displacement component in the direction perpendicular to the optical axis.

In the optical system OL1, focusing on from infinity to a close distance object is performed by moving the fourth lens group G4 as the focusing group GF to the image side on the optical axis.

Table 1 below shows values of specifications of the optical system OL1. In Table 1, the following specifications shown as overall specifications are defined as follows: f represents the overall focal length; Fno represents the F number; ω represents the half angle of view (maximum incident angle in the unit of [°]); Y represents the maximum image height; TL represents the total length at focusing at infinity; and BF represents the back focus at focusing at infinity in the wide-angle end state, an intermediate focal length state, and the telephoto end state. The total length TL is the distance on the optical axis from a lens surface (first surface) closest to the object side to the image plane I. The back focus BF is the distance on the optical axis from a lens surface (thirty-sixth surface) closest to the image plane side to the image plane I. In lens data, a first field m shows the sequence of lens surfaces (surface numbers) counted from the object side in a direction in which a ray travels, a second field r shows the radius of curvature of each lens surface, a third field d shows the distance (inter-surface distance) on the optical axis from each optical surface to the following optical surface, and a fourth field nd and a fifth field νd show the refractive index and the Abbe number at the d line (λ=587.6 nm). A radius of curvature of ∞ represents a flat surface, and the refractive index of air, which is 1.00000, is omitted. When a lens surface is an aspheric surface, a symbol * is provided on the right side of the surface number and the field of the radius of curvature r shows the paraxial radius of curvature. The lens group focal length shows the number of the first surface and the focal length of each lens group.

The unit of each of the focal length f, the radius r of curvature, the inter-surface distance d, and other lengths shown in all the variety of specifications below is typically “mm”, but not limited to this because the optical system provides the same optical performance even when the optical system is proportionally enlarged or reduced.

The description of the reference characters and the description of specification tables hold true for those in the following examples.

TABLE 1
First example
[Overall specifications]

| | Wide-angle | Intermediate | Telephoto |
|---|---|---|---|
| | end | focal length | end |
| f | 28.873 | 105.097 | 387.901 |
| Fno | 4.120 | 6.700 | 8.240 |
| ω | 38.431 | 11.277 | 3.185 |
| Y | 21.600 | 21.600 | 21.600 |
| TL | 152.057 | 191.145 | 245.508 |
| TL(air-conversion | 151.512 | 190.600 | 244.963 |
| length) | | | |
| BF | 12.257 | 27.533 | 57.439 |
| BF(air-conversion | 11.712 | 26.988 | 56.894 |
| length) | | | |

[Lens data]

| m | r | d | nd | νd |
|---|---|---|---|---|
| Object | ∞ | | | |
| plane | | | | |
| 1 | 129.35732 | 2.000 | 1.95375 | 32.33 |
| 2 | 82.75885 | 8.000 | 1.49782 | 82.57 |
| 3 | −912.99068 | 0.100 | | |
| 4 | 73.18388 | 6.454 | 1.49782 | 82.57 |
| 5 | 260.55354 | D5 | | |
| 6* | 73.50258 | 1.500 | 1.82098 | 42.50 |
| 7 | 17.60000 | 7.328 | | |
| 8 | −58.36123 | 1.100 | 1.80400 | 46.60 |
| 9 | 60.67144 | 0.100 | | |
| 10 | 33.64111 | 4.739 | 1.80809 | 22.74 |
| 11 | −106.89530 | 2.041 | | |
| 12 | −27.89006 | 1.175 | 1.61800 | 63.34 |
| 13 | −75.10124 | D13 | | |
| 14 | ∞ | 1.500 | | Aperture stop S |
| 15 | 70.50000 | 2.397 | 1.90265 | 35.77 |
| 16 | 1016.93660 | 0.100 | | |
| 17 | 21.60692 | 4.056 | 1.59255 | 67.86 |
| 18* | −1048.55670 | 2.963 | | |
| 19 | 84.00578 | 1.000 | 1.95375 | 32.33 |
| 20 | 15.55698 | 5.071 | 1.57501 | 41.51 |
| 21 | −45.79685 | 0.100 | | |
| 22 | −281.08943 | 1.000 | 1.95375 | 32.33 |
| 23 | 35.77543 | 2.174 | | |
| 24 | 48.66811 | 4.518 | 1.56732 | 42.58 |
| 25 | −23.87526 | 1.000 | 1.96300 | 24.11 |
| 26 | −45.48580 | 2.575 | | |
| 27 | 202.99645 | 1.000 | 1.95000 | 29.37 |
| 28 | 59.41596 | 3.303 | 1.62588 | 35.72 |
| 29 | −42.26381 | D29 | | |
| 30 | 46.48533 | 2.711 | 1.75520 | 27.57 |
| 31 | 294.73044 | 1.000 | 1.80400 | 46.60 |
| 32 | 22.58377 | D32 | | |
| 33 | 6126.20480 | 4.430 | 1.68893 | 31.16 |
| 34 | −46.03337 | 3.270 | | |
| 35 | −23.11252 | 1.529 | 1.74310 | 49.44 |
| 36* | −107.28268 | D36 | | |
| 37 | ∞ | 1.600 | 1.51680 | 63.88 |
| 38 | ∞ | D38 | | |
| Image | ∞ | | | |
| plane | | | | |

[Focal length of lens groups]

| | First | |
|---|---|---|
| Lens group | surface | Focal length |
| First lens group G1 | 1 | 136.614 |
| Second lens group G2 | 6 | −21.027 |
| Third lens group G3 | 14 | 30.114 |
| Fourth lens group G4 | 30 | −55.629 |
| Fifth lens group G5 | 33 | −113.557 |

In the optical system OL1, the sixth surface, the eighteenth surface, and the thirty-sixth surface are aspheric surfaces. Table 2 below shows aspheric surface data, in other words, the values of the conic constant K and the aspheric surface constants A4 to A12 for each surface.

TABLE 2
[Aspheric surface data]
Sixth surface K = 1

| | | |
|---|---|---|
| A4 = 8.20841E−07 | A6 = −1.18733E−09 | A8 = 1.11014E−11 |
| A10 = −2.88919E−14 | A12 = 3.53470E−17 | |

Eighteenth surface K = 1

| | | |
|---|---|---|
| A4 = 1.65728E−05 | A6 = −1.58066E−08 | A8 = −2.91412E−11 |
| A10 = 1.91506E−13 | A12 = 0.00000E+00 | |

Thirty-sixth surface K = 1

| | | |
|---|---|---|
| A4 = −1.31311E−05 | A6 = 2.25689E−09 | A8 = −2.12319E−11 |
| A10 = 2.62561E−15 | A12 = 0.00000E+00 | |

In the optical system OL1, an on-axis air space D5 between the first lens group G1 and the second lens group G2, an on-axis air space D13 between the second lens group G2 and the aperture stop S, an on-axis air space D29 between the third lens group G3 and the fourth lens group G4, an on-axis air space D32 between the fourth lens group G4 and the fifth lens group G5, an on-axis air space D36 between the fifth lens group G5 and the filter group FL, and an on-axis air space D38 between the filter group FL and the image plane I change at magnification change. Table 3 below shows variable spaces at focusing at infinity in the wide-angle end state, the intermediate focal length state, and the telephoto end state. Note that DO represents the distance on the optical axis from the lens surface (first surface) closest to the object side in the optical system OL1 to an object.

TABLE 3
[Variable space data]

| | | Intermediate focal | Telephoto |
|---|---|---|---|
| | Wide-angle end | length | end |
| D0 | ∞ | ∞ | ∞ |
| D5 | 1.500 | 47.465 | 85.000 |
| D13 | 35.508 | 10.236 | 1.500 |
| D29 | 1.500 | 12.906 | 1.500 |
| D32 | 21.059 | 12.771 | 19.836 |
| D36 | 9.600 | 24.741 | 54.831 |
| D38 | 1.057 | 1.192 | 1.008 |

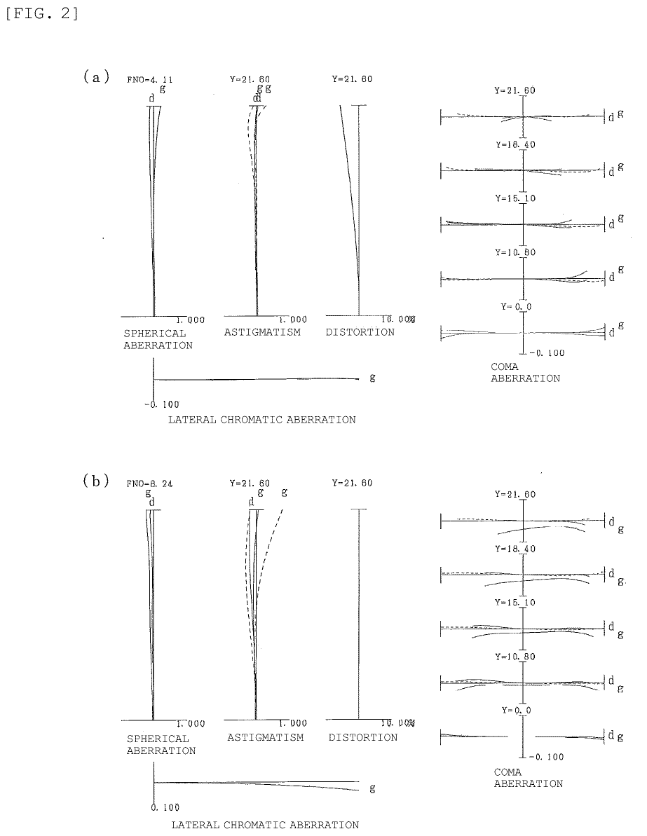

FIG. 2 shows a spherical aberration diagram, an astigmatism diagram, a distortion diagram, a lateral chromatic aberration diagram, and a coma aberration diagram of the optical system OL1 at focusing at infinity in the wide-angle end state and the telephoto end state. In each aberration diagram, FNO represents the F number, NA represents the numerical aperture, and Y represents the image height. Note that the spherical aberration diagram shows the value of the F number or NA corresponding to the maximum diameter, the astigmatism diagram and the distortion diagram each show the value of the image height, and the coma aberration diagram shows the value of each image height. In the spherical aberration diagram, the lateral chromatic aberration diagram, and the coma aberration diagram, reference character d represents the d-line (λ=587.6 nm), and reference character g represents the g-line (λ=435.8 nm). In the astigmatism diagram, the solid line represents the sagittal image plane, and the dashed line represents the meridional image plane. Further, in the aberration diagrams in the following examples, the same reference characters as those in the present example are used. The aberration diagrams show that the optical system OL1 allows favorable correction of the variety of aberrations and has excellent imaging performance.

### Second Example

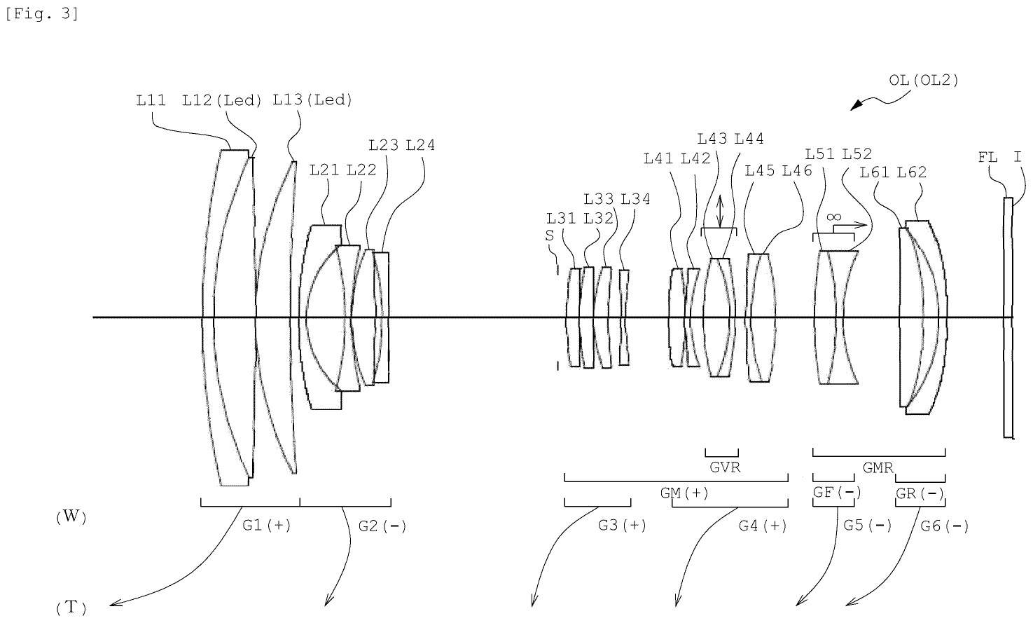

FIG. 3 is a diagram showing the configuration of an optical system OL2 according to a second example. The optical system OL2 includes, sequentially from the object side, a first lens group G1 having positive refractive power, a second lens group G2 having negative refractive power, a middle group GM constituted by a third lens group G3 having positive refractive power and a fourth lens group G4 having positive refractive power, a focusing group GF constituted by a fifth lens group G5 having negative refractive power, and a rear group GR constituted by a sixth lens group G6 having negative refractive power.

The first lens group G1 includes, sequentially from the object side, a cemented positive lens formed by cementing a negative meniscus lens L11 having a convex surface facing the object side and a biconvex positive lens L12, and a positive meniscus lens L13 having a convex surface facing the object side. Note that the biconvex positive lens L12 and the positive meniscus lens L13 are the specific lens Led.

The second lens group G2 includes, sequentially from the object side, a negative lens L21 having a negative meniscus shape with a convex surface facing the object side and with an aspheric surface formed on a lens surface on the object side, a biconcave negative lens L22, a biconvex positive lens L23, and a biconcave negative lens L24.

The third lens group G3 includes, sequentially from the object side, a positive meniscus lens L31 having a convex surface facing the object side, a biconvex positive lens L32, a positive meniscus lens L33 having a convex surface facing the object side, and a biconcave negative lens L34.

The fourth lens group G4 includes, sequentially from the object side, a positive lens L41 having a biconvex shape with an aspheric surface formed on a lens surface on the object side, a negative meniscus lens L42 having a convex surface facing the object side, a cemented positive lens formed by cementing a biconvex positive lens L43 and a negative meniscus lens L44 having a concave surface facing the object side, and a cemented positive lens formed by cementing a negative meniscus lens L45 having a convex surface facing the object side and a biconvex positive lens L46.

The fifth lens group G5 includes a cemented negative lens formed by cementing a biconvex positive lens L51 and a biconcave negative lens L52 sequentially from the object side.

The sixth lens group G6 includes, sequentially from the object side, a positive meniscus lens L61 having a concave surface facing the object side, and a negative lens L62 having a negative meniscus shape with a concave surface facing the object side and with an aspheric surface formed on a lens surface on the image side.

An aperture stop S is disposed between the second lens group G2 and the third lens group G3. In addition, a filter group FL is disposed between the sixth lens group G6 and an image plane I.

In the optical system OL2, the first lens group G1, the second lens group G2, the third lens group G3, the fourth lens group G4, the fifth lens group G5, and the sixth lens group G6 move on the optical axis so that the distance between lens groups adjacent to each other changes at magnification change from the wide-angle end state to the telephoto end state. Note that the aperture stop S moves together with the third lens group G3.

In the optical system OL2, image position correction (antivibration) when camera shake occurs is performed by moving, as the antivibration group GVR, the cemented positive lens formed by cementing the biconvex positive lens L43 and the negative meniscus lens L44 having a concave surface facing the object side in the fourth lens group G4, with a displacement component in the direction perpendicular to the optical axis.

In the optical system OL2, focusing on from infinity to a close distance object is performed by moving the fifth lens group G5 as the focusing group GF to the image side on the optical axis.

Table 4 below shows values of specifications of the optical system OL2.

TABLE 4
Second example
[Overall specifications]

| | Wide-angle | Intermediate | Telephoto |
|---|---|---|---|
| | end | focal length | end |
| f | 28.870 | 105.050 | 387.802 |
| Fno | 4.122 | 6.299 | 8.232 |
| ω | 37.744 | 11.387 | 3.199 |
| Y | 21.600 | 21.600 | 21.600 |
| TL | 152.017 | 189.954 | 245.469 |
| TL(air- | 151.471 | 189.409 | 244.923 |
| conversion | | | |
| length) | | | |
| BF | 12.216 | 22.220 | 55.667 |
| BF(air- | 11.671 | 21.675 | 55.122 |
| conversion | | | |
| length) | | | |

[Lens data]

| m | r | d | nd | νd |
|---|---|---|---|---|
| Object | ∞ | | | |
| plane | | | | |
| 1 | 144.77208 | 2.000 | 1.88300 | 40.69 |
| 2 | 70.05066 | 7.900 | 1.49782 | 82.57 |
| 3 | −1049.71040 | 0.100 | | |
| 4 | 65.17091 | 6.500 | 1.49782 | 82.57 |
| 5 | 380.61539 | D5 | | |
| 6* | 61.40685 | 1.500 | 1.79526 | 45.25 |
| 7 | 17.78512 | 7.271 | | |
| 8 | −52.18547 | 1.100 | 1.59319 | 67.90 |
| 9 | 50.73723 | 0.100 | | |
| 10 | 30.97159 | 4.469 | 1.84666 | 23.80 |
| 11 | −238.93300 | 1.309 | | |
| 12 | −44.48457 | 1.142 | 1.81600 | 46.59 |
| 13 | 473.42435 | D13 | | |
| 14 | ∞ | 1.500 | | Aperture stop S |
| 15 | 60.00000 | 2.290 | 1.64000 | 60.19 |
| 16 | 271.77460 | 0.100 | | |
| 17 | 48.60601 | 2.629 | 1.61800 | 63.34 |
| 18 | −3643.42920 | 0.100 | | |
| 19 | 28.06713 | 2.770 | 1.62041 | 60.24 |
| 20 | 79.18229 | 2.282 | | |
| 21 | −150.84463 | 1.000 | 1.95375 | 32.33 |
| 22 | 69.18543 | D22 | | |
| 23* | 51.38486 | 3.104 | 1.59255 | 67.86 |
| 24 | −56.26839 | 0.100 | | |
| 25 | 103.37188 | 1.000 | 1.84850 | 43.79 |
| 26 | 27.22020 | 2.396 | | |
| 27 | 43.74431 | 4.899 | 1.55298 | 55.07 |
| 28 | −27.61650 | 1.025 | 2.00100 | 29.12 |
| 29 | −51.35233 | 2.000 | | |
| 30 | 139.97848 | 1.080 | 2.00100 | 29.12 |
| 31 | 43.10791 | 4.563 | 1.60342 | 38.03 |
| 32 | −44.99649 | D32 | | |
| 33 | 73.54454 | 4.187 | 1.76182 | 26.58 |
| 34 | −49.37126 | 1.185 | 1.84850 | 43.79 |
| 35 | 28.32486 | D35 | | |
| 36 | −4472.92400 | 4.351 | 1.59551 | 39.21 |
| 37 | −49.28355 | 2.929 | | |
| 38 | −25.60265 | 1.574 | 1.79526 | 45.25 |
| 39* | −63.85674 | D39 | | |
| 40 | ∞ | 1.600 | 1.51680 | 63.88 |
| 41 | ∞ | D41 | | |
| Image | ∞ | | | |
| plane | | | | |

[Focal length of lens groups]

| | First | Focal |
|---|---|---|
| Lens group | surface | length |
| First lens group G1 | 1 | 134.719 |
| Second lens group G2 | 6 | −20.941 |
| Third lens group G3 | 14 | 51.774 |
| Fourth lens group G4 | 23 | 40.546 |
| Fifth lens group G5 | 33 | −49.005 |
| Sixth lens group G6 | 36 | −172.075 |

In the optical system OL2, the sixth surface, the twenty-third surface, and the thirty-ninth surface are aspheric surfaces. Table 5 below shows aspheric surface data, in other words, the values of the conic constant K and the aspheric surface constants A4 to A12 for each surface.

TABLE 5
[Aspheric surface data]
Sixth surface K = 1

| | | |
|---|---|---|
| A4 = 4.52952E−07 | A6 = −1.23718E−09 | A8 = −1.26456E−11 |
| A10 = 5.59093E−14 | A12 = −7.53610E−17 | |

Twenty-third surface K = 1

| | | |
|---|---|---|
| A4 = −1.46737E−05 | A6 = 1.14868E−08 | A8 = −1.16420E−11 |
| A10 = −4.00173E−14 | A12 = 0.00000E+00 | |

Thirty-nineth surface K = 1

| | | |
|---|---|---|
| A4 = −8.13861E−06 | A6 = −2.19937E−10 | A8 = −1.39052E−11 |
| A10 = 2.41034E−14 | A12 = −4.96300E−17 | |

In the optical system OL2, an on-axis air space D5 between the first lens group G1 and the second lens group G2, an on-axis air space D13 between the second lens group G2 and the aperture stop S, an on-axis air space D22 between the third lens group G3 and the fourth lens group G4, an on-axis air space D32 between the fourth lens group G4 and the fifth lens group G5, an on-axis air space D35 between the fifth lens group G5 and the sixth lens group G6, an on-axis air space D39 between the sixth lens group G6 and the filter group FL, and an on-axis air space D41 between the filter group FL and the image plane I change at magnification change. Table 6 below shows variable spaces at focusing at infinity in the wide-angle end state, the intermediate focal length state, and the telephoto end state.

TABLE 6
[Variable space data]

| | Wide-angle | Intermediate focal | |
|---|---|---|---|
| | end | length | Telephoto end |
| D0 | ∞ | ∞ | ∞ |
| D5 | 1.500 | 41.194 | 85.000 |
| D13 | 31.922 | 9.093 | 1.569 |
| D22 | 7.937 | 1.776 | 1.500 |
| D32 | 7.164 | 14.644 | 1.500 |
| D35 | 10.822 | 20.572 | 19.779 |
| D39 | 10.500 | 20.412 | 53.998 |
| D41 | 0.117 | 0.208 | 0.069 |

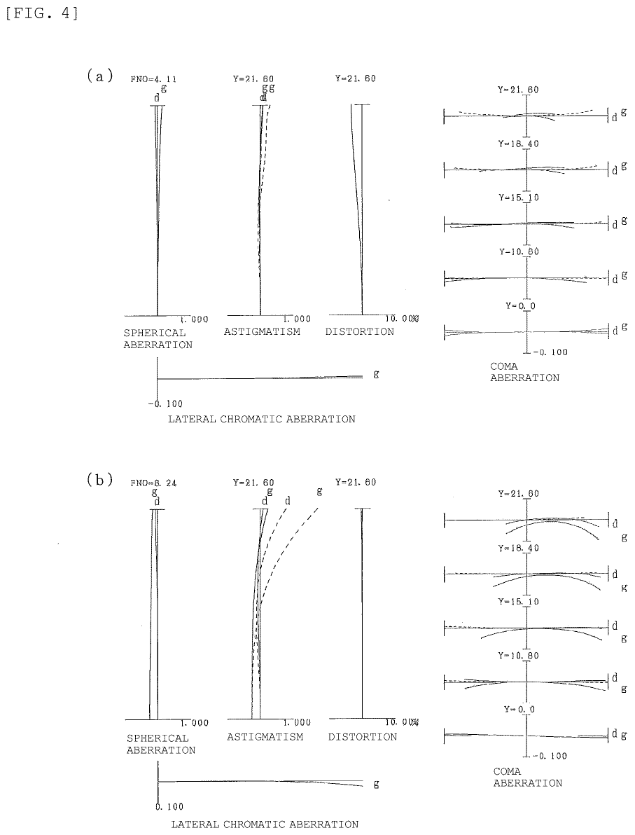

FIG. 4 shows a spherical aberration diagram, an astigmatism diagram, a distortion diagram, a lateral chromatic aberration diagram, and a coma aberration diagram of the optical system OL2 at focusing at infinity in the wide-angle end state and the telephoto end state. The aberration diagrams show that the optical system OL2 allows favorable correction of the variety of aberrations and has excellent imaging performance.

### Third Example

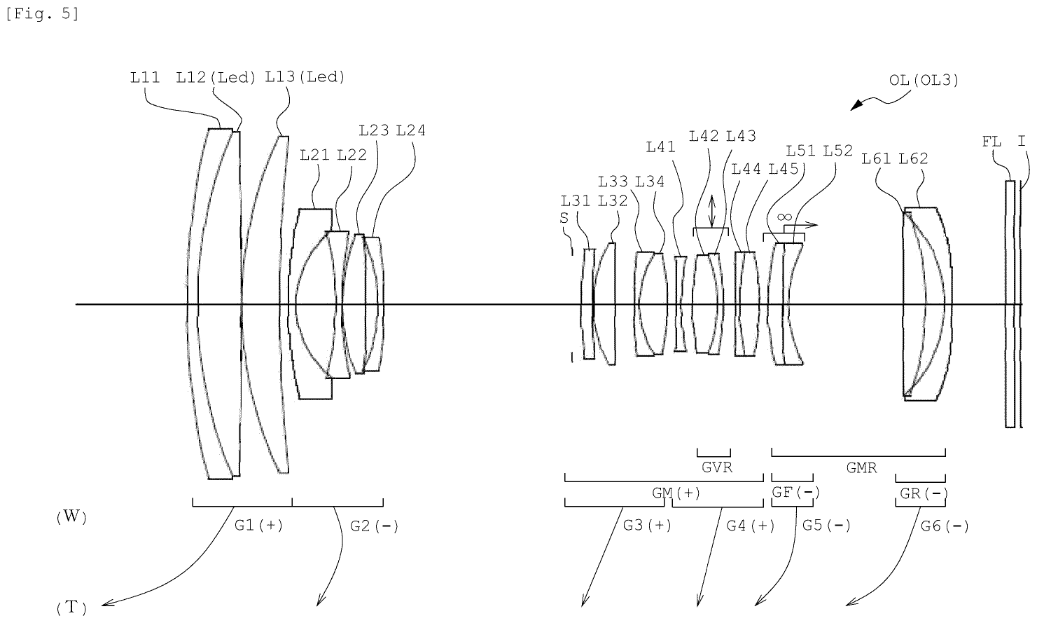

FIG. 5 is a diagram showing the configuration of an optical system OL3 according to a third example. The optical system OL3 includes, sequentially from the object side, a first lens group G1 having positive refractive power, a second lens group G2 having negative refractive power, a middle group GM constituted by a third lens group G3 having positive refractive power and a fourth lens group G4 having positive refractive power, a focusing group GF constituted by a fifth lens group G5 having negative refractive power, and a rear group GR constituted by a sixth lens group G6 having negative refractive power.

The first lens group G1 includes, sequentially from the object side, a cemented positive lens formed by cementing a negative meniscus lens L11 having a convex surface facing the object side and a biconvex positive lens L12, and a positive meniscus lens L13 having a convex surface facing the object side. Note that the biconvex positive lens L12 and the positive meniscus lens L13 are the specific lens Led.

The second lens group G2 includes, sequentially from the object side, a negative lens L21 having a negative meniscus shape with a convex surface facing the object side and with an aspheric surface formed on a lens surface on the object side, a biconcave negative lens L22, a biconvex positive lens L23, and a negative meniscus lens L24 having a concave surface facing the object side.

The third lens group G3 includes, sequentially from the object side, a positive meniscus lens L31 having a convex surface facing the object side, a positive lens L32 having a biconvex shape with an aspheric surface formed on a lens surface on the object side, and a cemented positive lens formed by cementing a negative meniscus lens L33 having a convex surface facing the object side and a biconvex positive lens L34.

The fourth lens group G4 includes, sequentially from the object side, a biconcave negative lens L41, a cemented positive lens formed by cementing a biconvex positive lens L42 and a negative meniscus lens L43 having a concave surface facing the object side, and a cemented positive lens formed by cementing a negative meniscus lens L44 having a convex surface facing the object side and a biconvex positive lens L45.

the fifth lens group G5 includes a cemented negative lens formed by cementing a positive meniscus lens L51 having a convex surface facing the object side and a negative meniscus lens L52 having a convex surface facing the object side sequentially from the object side.

The sixth lens group G6 includes, sequentially from the object side, a positive meniscus lens L61 having a concave surface facing the object side and a negative lens L62 having a negative meniscus shape with a concave surface facing the object side and with an aspheric surface formed on a lens surface on the image side.

An aperture stop S is disposed between the second lens group G2 and the third lens group G3. In addition, a filter group FL is disposed between the sixth lens group G6 and an image plane I.

In the optical system OL3, the first lens group G1, the second lens group G2, the third lens group G3, the fourth lens group G4, the fifth lens group G5, and the sixth lens group G6 move on the optical axis so that the distance between lens groups adjacent to each other changes at magnification change from the wide-angle end state to the telephoto end state. Note that the aperture stop S moves together with the third lens group G3.

In the optical system OL3, image position correction (antivibration) when camera shake occurs is performed by moving, as the antivibration group GVR, the cemented positive lens formed by cementing the biconvex positive lens L42 and the negative meniscus lens L43 having a concave surface facing the object side in the fourth lens group G4, with a displacement component in the direction perpendicular to the optical axis.

In the optical system OL3, focusing on from infinity to a close distance object is performed by moving the fifth lens group G5 as the focusing group GF to the image side on the optical axis.

Table 7 below shows values of specifications of the optical system OL3.

TABLE 7
Third example
[Overall specifications]

| | Wide- | Intermediate | Telephoto |
|---|---|---|---|
| | angle end | focal length | end |
| f | 28.878 | 105.140 | 387.850 |
| Fno | 4.122 | 6.304 | 8.231 |
| ω | 38.659 | 11.321 | 3.176 |
| Y | 21.600 | 21.600 | 21.600 |
| TL | 152.093 | 194.157 | 245.491 |
| TL(air- | 151.548 | 193.612 | 244.946 |
| conversion | | | |
| length) | | | |
| BF | 12.293 | 30.236 | 55.360 |
| BF(air- | 11.748 | 29.691 | 54.815 |
| conversion | | | |
| length) | | | |

[Lens data]

| m | r | d | nd | νd |
|---|---|---|---|---|
| Object | ∞ | | | |
| plane | | | | |
| 1 | 129.84788 | 2.000 | 1.95375 | 32.33 |
| 2 | 81.64936 | 8.000 | 1.49782 | 82.57 |
| 3 | −1216.43210 | 0.100 | | |
| 4 | 72.61946 | 6.900 | 1.49782 | 82.57 |
| 5 | 291.11042 | D5 | | |
| 6* | 70.31159 | 1.500 | 1.79063 | 44.98 |
| 7 | 17.07399 | 7.193 | | |
| 8 | −52.72344 | 1.100 | 1.77250 | 49.62 |
| 9 | 63.28304 | 0.100 | | |
| 10 | 33.57086 | 4.448 | 1.80809 | 22.74 |
| 11 | −147.53819 | 2.129 | | |
| 12 | −27.85587 | 1.152 | 1.61800 | 63.34 |
| 13 | −70.53320 | D13 | | |
| 14 | ∞ | 1.500 | | Aperture stop S |
| 15 | 70.00000 | 2.204 | 1.90265 | 35.77 |
| 16 | 193.55302 | 0.100 | | |
| 17 | 23.30526 | 3.945 | 1.59255 | 67.86 |
| 18* | −300.05224 | 3.419 | | |
| 19 | 84.48527 | 1.000 | 1.95375 | 32.33 |
| 20 | 16.75261 | 5.112 | 1.56732 | 42.58 |
| 21 | −42.34604 | D21 | | |
| 22 | −264.47022 | 1.000 | 1.95375 | 32.33 |
| 23 | 42.69249 | 2.037 | | |
| 24 | 48.26641 | 4.693 | 1.56732 | 42.58 |
| 25 | −23.62961 | 1.000 | 1.96300 | 24.11 |
| 26 | −45.28115 | 2.000 | | |
| 27 | 213.48670 | 1.000 | 1.95000 | 29.37 |
| 28 | 49.45148 | 3.607 | 1.64769 | 33.72 |
| 29 | −40.88986 | D29 | | |
| 30 | 45.14914 | 2.731 | 1.78472 | 25.64 |
| 31 | 302.93241 | 1.000 | 1.84850 | 43.79 |
| 32 | 23.13479 | D32 | | |
| 33 | −1020.79810 | 4.044 | 1.67270 | 32.18 |
| 34 | −48.90910 | 3.455 | | |
| 35 | −22.53475 | 1.501 | 1.74310 | 49.44 |
| 36* | −90.62463 | D36 | | |
| 37 | ∞ | 1.600 | 1.51680 | 63.88 |
| 38 | ∞ | D38 | | |
| Image | ∞ | | | |
| plane | | | | |

[Focal length of lens groups]

| | First | Focal |
|---|---|---|
| Lens group | surface | length |
| First lens group G1 | 1 | 136.397 |
| Second lens group G2 | 6 | −20.450 |
| Third lens group G3 | 14 | 28.221 |
| Fourth lens group G4 | 22 | 123.846 |
| Fifth lens group G5 | 30 | −56.286 |
| Sixth lens group G6 | 33 | −95.732 |

In the optical system OL3, the sixth surface, the eighteenth surface, and the thirty-sixth surface are aspheric surfaces. Table 8 below shows aspheric surface data, in other words, the values of the conic constant K and the aspheric surface constants A4 to A12 for each surface.

TABLE 8
[Aspheric surface data]
Sixth surface K = 1

| | | |
|---|---|---|
| A4 = 7.09821E−07 | A6 = −8.44593E−10 | A8 = 9.02282E−13 |
| A10 = 2.46444E−15 | A12 = 0.00000E+00 | |

Eighteenth surface K = 1

| | | |
|---|---|---|
| A4 = 1.70092E−05 | A6 = −1.36361E−08 | A8 = −4.62697E−11 |
| A10 = 2.44113E−13 | A12 = 0.00000E+00 | |

Thirty-sixth surface K = 1

| | | |
|---|---|---|
| A4 = −1.28475E−05 | A6 = 4.54914E−10 | A8 = −1.09068E−11 |
| A10 = −1.39907E−14 | A12 = 0.00000E+00 | |

In the optical system OL3, an on-axis air space D5 between the first lens group G1 and the second lens group G2, an on-axis air space D13 between the second lens group G2 and the aperture stop S, an on-axis air space D21 between the third lens group G3 and the fourth lens group G4, an on-axis air space D29 between the fourth lens group G4 and the fifth lens group G5, an on-axis air space D32 between the fifth lens group G5 and the sixth lens group G6, an on-axis air space D36 between the sixth lens group G6 and the filter group FL, and an on-axis air space D38 between the filter group FL and the image plane I change at magnification change. Table 9 below shows variable spaces at focusing at infinity in the wide-angle end state, the intermediate focal length state, and the telephoto end state.

TABLE 9
[Variable space data]

| | Wide-angle | Intermediate focal | |
|---|---|---|---|
| | end | length | Telephoto end |
| D0 | ∞ | ∞ | ∞ |
| D5 | 1.500 | 47.034 | 84.600 |
| D13 | 34.332 | 11.009 | 1.500 |
| D21 | 1.500 | 2.290 | 2.934 |
| D29 | 1.500 | 10.833 | 1.500 |
| D32 | 20.998 | 12.784 | 19.626 |
| D36 | 9.600 | 27.435 | 52.770 |
| D38 | 1.093 | 1.201 | 0.991 |

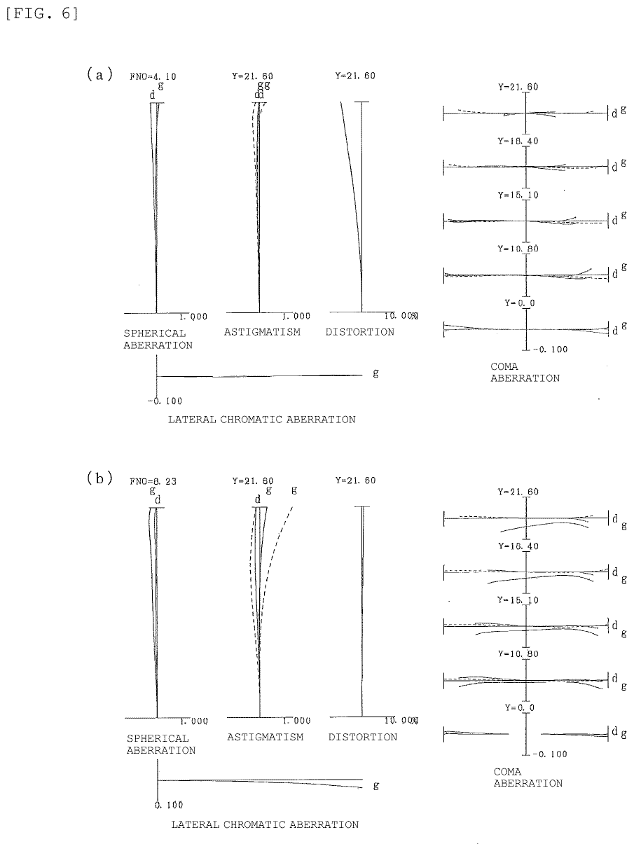

FIG. 6 shows a spherical aberration diagram, an astigmatism diagram, a distortion diagram, a lateral chromatic aberration diagram, and a coma aberration diagram of the optical system OL3 at focusing at infinity in the wide-angle end state and the telephoto end state. The aberration diagrams show that the optical system OL3 allows favorable correction of the variety of aberrations and has excellent imaging performance.

[Condition Expression Correspondence Values]

Table 10 below shows correspondence values of Conditional Expressions (1) to (14) in the first to third examples.

TABLE 10

(1) f1/(−f2)
(2) Bfaw/fw
(3) |fMRw/fMw|
(4) TLt/ft
(5) fMw/(−f2)
(6) (−fF)/fMw
(7) |fMw/fRw|
(8) |fF/fRw|
(9) |f2/fRw|
(10) βFt/βFw
(11) βRt/βRw
(12) fMw/fVR
(13) |fVR/fF|
(14) νd1

| | First example | Second example | Third example |
|---|---|---|---|
| fMw | 30.114 | 32.700 | 30.169 |
| fMRw | −31.647 | −35.075 | −29.824 |
| fVR | 61.927 | 63.251 | 61.864 |
| βFw | 1.675 | 1.559 | 1.656 |
| βRw | 1.067 | 1.049 | 1.095 |
| βFt | 2.173 | 2.391 | 2.085 |
| βRt | 1.465 | 1.301 | 1.545 |
| (1) | 6.497 | 6.433 | 6.670 |
| (2) | 0.406 | 0.404 | 0.407 |
| (3) | 1.051 | 1.073 | 0.989 |
| (4) | 0.632 | 0.632 | 0.632 |
| (5) | 1.432 | 1.561 | 1.475 |
| (6) | 1.847 | 1.499 | 1.866 |
| (7) | 0.265 | 0.190 | 0.315 |
| (8) | 0.490 | 0.285 | 0.588 |
| (9) | 0.185 | 0.122 | 0.214 |
| (10) | 1.297 | 1.534 | 1.258 |
| (11) | 1.373 | 1.241 | 1.411 |
| (12) | 0.486 | 0.517 | 0.488 |
| (13) | 1.113 | 1.291 | 1.099 |
| (14) | 82.57 | 82.57 | 82.57 |

Note that the contents described below are employable as appropriate to the extent that optical performance is not compromised.

In the present embodiment, the optical system OL having a five- or six-group configuration has been shown above, and configurations, conditions, and others described above are also applicable to a seven-group configuration, an eight-group configuration, and other group configurations. Further, the optical system OL may have a configuration in which a lens or a lens group closest to the object side is added or a configuration in which a lens or a lens group closest to the image plane side is added. Specifically, the optical system OL may have a configuration in which a lens group having a fixed position relative to the image plane at magnification change or focusing is added closest to the image plane side. The lens group (also simply referred to as a “group”) represents a portion including at least one lens separated from another by an air space that changes at magnification change or focusing. A lens component represents a single lens or a cemented lens formed by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven with a motor for autofocusing (such as an ultrasonic wave motor). In particular, the focusing group is preferably at least part of the fourth lens group G4 or the fifth lens group G5. Moreover, any lens other than the focusing group preferably has a fixed position relative to the image plane at focusing. The focusing group is preferably configured as a single lens or one lens component with a load on the motor taken into consideration.

An antivibration group may be a lens group or a partial lens group so moved as to have a displacement component in the direction perpendicular to the optical axis or rotated (swung) in an in-plane direction containing the optical axis to correct image blur caused by camera shake. In particular, it is preferable that the antivibration group is at least part of the third lens group G3 or the fourth lens group G4.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

The aperture stop S is preferably disposed between the second lens group G2 and the middle group GM (third lens group G3). Instead, no member as an aperture stop may be provided, and the frame of a lens may serve as the aperture stop.

Further, each lens surface may be provided with an antireflection film having high transmittance over a wide wavelength range to achieve good optical performance that reduces flare and ghost and achieves high contrast.

### REFERENCE SIGNS LIST

1 camera (optical apparatus)
OL (OL1 to OL3) optical system
G1 first lens group
G2 second lens group
GM middle group
GF focusing group
GR rear group
GVR antivibration group

1. An optical system comprising, in order from an object side:
a first lens group having positive refractive power;
a second lens group having negative refractive power;
a middle group constituted by one or two lens groups and having positive refractive power;
a focusing group that is a lens group having negative refractive power and moves in an optical axis direction at focusing; and
a rear group constituted by at least one lens group, wherein
respective distances between adjacent lens groups change at magnification change from a wide-angle end state to a telephoto end state, and
the following conditional expressions are satisfied:
$$\begin{matrix}1. < f 1 / ( - f 2 ) < 10. \\ 0.01 < Bfaw / fw < 0.55\end{matrix}$$
where
f1: focal length of the first lens group,
f2: focal length of the second lens group,
Bfaw: back focus (air-conversion length) of the optical system in the wide-angle end state, and
fw: overall focal length of the optical system in the wide-angle end state.

2. An optical system comprising, in order from an object side:
a first lens group having positive refractive power;
a second lens group having negative refractive power;
a middle group constituted by one or two lens groups and having positive refractive power;
a focusing group that is a lens group having negative refractive power and moves in an optical axis direction at focusing; and
a rear group constituted by at least one lens group, wherein
respective distances between adjacent lens groups change at magnification change from a wide-angle end state to a telephoto end state, and
the following conditional expressions are satisfied:
$$\begin{matrix}0.01 < \vert fMRw / fMw \vert < 5. \\ 0.01 < TLt / f t < 1.5\end{matrix}$$
where
fMRw: combined focal length of lens groups disposed on an image side of the middle group in the wide-angle end state,
fMw: focal length of the middle group in the wide-angle end state,
TLt: total length of the optical system in the telephoto end state, and
ft: overall focal length of the optical system in the telephoto end state.

3. The optical system according to claim 1, wherein the following conditional expression is satisfied:
$$0.01 < \vert fMRw / fMw \vert < 5.$$
where
fMRw: combined focal length of lens groups disposed on an image side of the middle group in the wide-angle end state, and
fMw: focal length of the middle group in the wide-angle end state.

4. The optical system according to claim 1, wherein the following conditional expression is satisfied:
$$0.01 < TLt / ft < 1.5$$
where
TLt: total length of the optical system in the telephoto end state, and
ft: overall focal length of the optical system in the telephoto end state.

5. The optical system according to claim 2, wherein the following conditional expression is satisfied:
$$1. < f 1 / ( - f 2 ) < 10.$$
where
f1: focal length of the first lens group, and
f2: focal length of the second lens group.

6. The optical system according to claim 2, wherein the following conditional expression is satisfied:
$$0.01 < Bfaw / fw < 0.55$$
where
Bfaw: back focus (air-conversion length) of the optical system in the wide-angle end state, and
fw: overall focal length of the optical system in the wide-angle end state.

7. The optical system according to claim 1, wherein the following conditional expression is satisfied:
$$0.5 < fMw / ( - f 2 ) < 3.$$
where
f2: focal length of the second lens group.

8. The optical system according to claim 1, wherein the following conditional expression is satisfied:
$$0.5 < ( - fF ) / fMw < 4.$$
where
fF: focal length of the focusing group, and
fMw: focal length of the middle group in the wide-angle end state.

9. The optical system according to claim 1, wherein the following conditional expression is satisfied:
$$0.01 < \vert fMw / fRw \vert < 1.$$
where
fMw: focal length of the middle group in the wide-angle end state, and
fRw: focal length of the rear group in the wide-angle end state.

10. The optical system according to claim 1, wherein the following conditional expression is satisfied:
$$0.01 < \vert fF / fRw \vert < 1.$$
where
fF: focal length of the focusing group, and
fRw: focal length of the rear group in the wide-angle end state.

11. The optical system according to claim 1, wherein the following conditional expression is satisfied:
$$0.01 < \vert f 2 / fRw \vert < 1.$$
where
f2: focal length of the second lens group, and
fRw: focal length of the rear group in the wide-angle end state.

12. The optical system according to claim 1, wherein the following conditional expression is satisfied:
$$0.01 < β Ft / β Fw < 2.$$
where
βFt: lateral magnification of the focusing group in the telephoto end state, and
βFw: lateral magnification of the focusing group in the wide-angle end state.

13. The optical system according to claim 1, wherein the following conditional expression is satisfied:
$$0.01 < β Rt / β Rw < 2.$$
where
βRt: lateral magnification of the rear group in the telephoto end state, and
βRw: lateral magnification of the rear group in the wide-angle end state.

14. The optical system according to claim 1, wherein at least part of the middle group is an antivibration group that moves with a movement component in a direction perpendicular to an optical axis.

15. The optical system according to claim 14, wherein the following conditional expression is satisfied:
$$0.01 < fMw / fVR < 1.5$$
where
fMw: focal length of the middle group in the wide-angle end state, and
fVR: focal length of the antivibration group.

16. The optical system according to claim 14, wherein the following conditional expression is satisfied:
$$0.01 < \vert fVR / fF \vert < 2.$$
where
fVR: focal length of the antivibration group, and
fF: focal length of the focusing group.

17. The optical system according to claim 14, wherein the antivibration group is disposed between a lens component disposed closest to the object side and a lens component disposed closest to an image side in the middle group.

18. The optical system according to claim 14, wherein the antivibration group is constituted by one cemented lens.

19. (canceled)

20. The optical system according to claim 1, wherein the rear group has negative refractive power.

21. The optical system according to claim 1, wherein the first lens group includes a lens that satisfies the following conditional expression:
$$vd 1 > 75.$$
where
νd1: Abbe number of a medium of the lens at a d line.

22. An optical apparatus including the optical system according to claim 1.

23. A method for manufacturing an optical system including, in order from an object side, first lens group having positive refractive power, a second lens group having negative refractive power, a middle group constituted by one or two lens groups and having positive refractive power, a focusing group that is a lens group having negative refractive power and moves in an optical axis direction at focusing, and a rear group constituted by at least one lens group, the method comprising:
disposing the lens groups so that respective distances between adjacent lens groups change at magnification change from a wide-angle end state to a telephoto end state; and
satisfying the following conditional expressions:
$$\begin{matrix}1. < f 1 / ( - f 2 ) < 10. \\ 0.01 < Bfaw / fw < 0.55\end{matrix}$$
where
f1: focal length of the first lens group,
f2: focal length of the second lens group,
Bfaw: back focus (air-conversion length) of the optical system in the wide-angle end state, and
fw: overall focal length of the optical system in the wide-angle end state.
